(19) United States
(12) Patent Application Publication
(10) Pub. No.: US 2002/0077893 A1
(43) Pub. Date: Jun. 20, 2002

(54) Real estate rebate system and method

(76) Inventors: Andrew Louis Wolf, Bloomingdale, IL (US); John Robert Oltman, Wheaton, IL (US)

Correspondence Address: STEVENS, DAVIS, MILLER & MOSHER, L.L.P., Suite 850, 1615 L Street, N.W., Washington, DC, 20036, US

(21) Appl. No.: 09/739,122

(22) Filed: Dec. 19, 2000

(51) Int. Cl. G06F 17/60

(52) U.S. Cl. 705/14

(57) ABSTRACT

A method and apparatus are provided for a communications network accessible hosted system that generates real estate commission revenues and processes self-service rebate coupons for principals in a real estate purchase transaction without a licensed real estate agent being physically present. Home sellers can list their properties with a host of the present invention at no upfront cost. The host allows homebuyers to research properties that meet their selection criteria. In a preferred embodiment, the present invention provides network access to hosted databases and matching services based on homebuyer needs, including ranked listing inventory, and generates custom coupons or registers pre-printed coupons for selected properties. The coupons are accepted by the seller and certify the host as the referring party. If a sale results, the host earns a commission from the home seller, while the homebuyer earns a rebate from the host.

### BACKGROUND OF THE INVENTION

1. Field of the Invention

The present invention relates to a system and method of purchasing real estate. More particularly, the present invention is directed to a Web-based and Internet-accessible, seller-to-buyer hosted real estate system that provides self-service cash back coupons to users who redeem them after they close on the property.

2. Discussion of the Prior Art

The prior art business model for buying real estate generally requires a real estate agent in the field who collects a fee from the seller on closing. This real estate agent first obtains buyer criteria and then performs a filtering process, matching buyer criteria with characteristics of available properties, to identify matching properties. Subsequently, the real estate agent escorts the prospective buyer on a tour of matching properties found by the agent. Commissions paid for these services by the seller to the buyer's real estate agent (either directly or through the seller's agent) are typically on the order of 3% of the selling price. The seller effectively passes these costs on to the buyer via a higher selling price for the property.

Importantly, within this prior art business model for buying real estate, in order for the real estate agent to receive a commission the real estate agent typically is required to be physically present in the field with the buyer when they make their first visit to a builder's sales office or when they tour other sellers' properties. Builders and other sellers, whether directly or through their listing or selling agents, offer a commission to “cooperating brokers.” Cooperating brokers are generally defined as brokers or agents that are a party to a purchase, often representing the buyer, but that are not the listing or selling agent. Commissions are generally defined as any performance-related fee pertaining to the sale of real estate paid by the seller, or other party to the closing, to a real estate broker. Commissions may be paid directly by the seller to the broker, or paid by the seller to the seller's listing broker who then in turn shares the fee with the cooperating broker, or paid by a party to the closing (such as the closing agent) to the broker as part of the HUD-1 Settlement Statement and closing. Commissions are distinct from advertising or marketing fees in that commissions are performance-based while advertising or marketing fees are paid regardless of performance.

Internet access to Web sites offering property listings using Web browsers has reduced the need for a real estate agent in the field for those buyers willing to do their own legwork. A buyer, shopping for a property, can search Internet-accessible inventories of available properties and filter through this available inventory using a Web browser. In doing so, the buyer is performing most or all of the filtering work previously performed by a real estate agent in the field. Filtering operations are typically based upon such criteria as awareness, location, price, quality, style, functionality, etc. The Internet provides a superior environment for performing this function since it provides the buyer direct control over the filter criteria, and is available twenty-four hours a day, seven days a week and on the buyer's schedule instead of a field agent's. The buyer can also revise criteria in real-time based on responses received. The buyer ultimately can then tour matching properties without an escorting real estate agent to decide if the property meets the buyer's needs.

Real estate matching services are well known in the art. Typical of the matching services offered is the system and method taught by Fraser, U.S. Pat. No. 5,664,115, the contents of which are hereby incorporated by reference. Fraser teaches automatically matching sellers of property with potential buyers through a communications network (preferably the Internet). Fraser's system is a hosted system that first obtains and stores information from sellers about each property to be listed by the host for sale. The host system creates and maintains a database of listings of available properties and sellers. Each potential buyer provides selection criteria that are stored in a provisional buyer record and matched with database listings of available properties. If the buyer is interested in a matching property, the buyer's qualifications for financing are solicited, stored in the buyer's provisional record, and matched with each matching property's financing requirements. If the buyer qualifies, the buyer is asked if it is desired to forward the buyer's information to the seller(s). If not, the buyer's record remains provisional. If, on the other hand, the buyer wishes to contact the seller, the buyer's record is recorded in the host's database, the matching seller and property records are updated to reference the buyer's database record, and the buyer's information is forwarded to the seller. In Fraser's system, the seller funds the host's services by paying a listing fee up front for each property listed. In return, sellers receive information regarding potential buyers as well as referrals. There is no buyer rebate taught by Fraser's system and method.

Web-based, Internet-accessible, reduced fee real estate buyer services are also well known in the art. Many real estate Web sites offer buyers visiting them a ‘buyer rebate’, provided a purchase of a property listing made available by the Web site results from the use of the services offered by the Web site. A real estate “rebate” is defined as any form of compensation or incentive provided, directly or indirectly, by a real estate agent to a principal in the real estate transaction. A rebate can be in the form of cash, goods or services and may be provided to the principal either directly by the real estate agent or through reductions of closing costs and the like owed by the principal as part of the transaction's HUD-1 Settlement Statement. Providers of buyer rebates range from full service realtor brokerages to independent real estate brokers. eRealty.com is one full service realtor brokerage maintaining a Web site that claims to provide buyers with access to nearly a half million properties online. Buyers are offered cash back amounting 1% of the purchase price of a home if they use eRealty.com as their buyer broker. eRealty.com claims to have reduced the cost of the home buying process by taking advantage of the Internet. The cash back rebate, in this case, is paid by eRealty.com to the buyer by offsetting a portion of the buyer's closing costs on the HUD-1 Settlement (closing) Statement, with a corresponding reduction of the buyer broker's commission. This amounts to a rebate at closing and where the rebate is included on the HUD-1 Settlement Statement, such rebates may require pre-approval by the lender.

Other types of Web-based realtor assistance to buyers range from full brokerage representation with a 25% (0.75% of selling price) rebate from agent commission, to a 33% (1% of selling price) rebate from agent commission for assisting with a home search, to a fixed fee for assisting with a ‘for sale by owner’ purchase. HomeFox.com, eHome.com, and zipRealty.com are among Web sites offering these and additional services. One site, RealEstateRebates.com, offers both buyers and sellers help in finding agents that offer rebates and discounts, respectively, in different areas of the country. RealEstateRebates.com prequalifies agents in different parts of the country for participation in their referral service. Still other types of Web-based and Internet-accessible referral services are available that give their users a rebate on their referral fees, which, at NextRoof.com, amounts to 0.5% of the selling price. Other rebate business models, such as the one offered by homebuyerrebate.com, include pre-qualification for financing and oversight of the purchase process.

None of these prior art real estate buyer rebate models have used the most common buyer incentive offered by retailers, the self-service rebate coupon. There is a long history of retailers offering consumers ‘cents-off’, discount, and cash back coupons as purchase incentives. Such coupons have been delivered door-to-door, in mailers, by downloading over the Internet, by e-mail, by facsimile, on-site at retail establishments, in newspaper advertisements and have even been personalized interactively to a particular consumer target. Many variations of couponing are available in the prior art.

At least one prior art patent has suggested applying coupons, rebates and vouchers to shopping for real estate. In U.S. Pat. No. 6,055,514, the contents of which are hereby incorporated by reference, Wren teaches a hosted system for shopping for goods and services, including real estate, which connects buyers and sellers (or their agents) via communications links and allows buyers to search for products in goods and services databases. A buyer is able to negotiate a price, arrange for financing, payment, insurance, etc., using the system taught by Wren. In Wren, the host exacts a payment of some kind from the customer for each instance a customer is shown product information, e.g., requiring the customer to view a specified amount of product information or charging a set fee per product viewed. However, Wren does not advocate replacing the agent with the system taught. To the contrary, Wren both discloses and claims means to interact with a knowledgeable sales representative provided by the host. In Wren, the host charges a fee for providing such services which the host can then offset by a host-sponsored coupon, rebate or voucher for free goods and services or an equivalent or partial discount, should the customer purchase goods and services offered through the host.

In much the same way as taught by Wren, real estate buyer rebate programs typically sign up real estate agents in advance and fund rebates by assessing the agent a fee, either up front or at some time during the processing of the real estate property purchase. Similarly, retailers are signed up to honor manufacturer coupons. Coupons are targeted to specific consumer groups, are funded by product manufacturers, and are paid by retailers directly to consumers at the point of purchase. Retailers then submit the redeemed coupons to the manufacturers for a refund. Couponing is a highly successful marketing technique. It is self-service and economically efficient. But it does require advance sign up by retailers to be successful.

One real estate Web site, InterNest.com, has provided a limited proof-of-concept implementation of a business model incorporating a self-service rebate coupon and eliminating the agent in the field. A potential buyer can search this Web site's listings and can request a self-service rebate coupon for a single property, which is then delivered either by e-mail or U.S. mail. Only builders of newly constructed homes are signed up in advance, by the host of this Web site, to honor these self-service rebate coupons. Additionally, a potential buyer only has access to homebuilder listings maintained by the host of this Web site. The host of the Web site is paid a fee by the homebuilder for providing matching services between the builder and potential buyers. This fee is paid by the homebuilder only after a sale is closed for one of the homebuilder's properties listed by the host's Web site and only if that sale results directly (with no agent) from the use of the host's Web site. After receipt of this fee the host funds the rebate to the buyer.

The increasing availability of rebates to Web-based real estate buyers is testimony to the widespread industry recognition that buyers are assuming much of the burden and time commitment for finding properties and should realize a financial benefit in return. While there is also recognition that the real estate matching services should not be free, with the exception of the proof-of-concept system noted above, prior art rebates to the property buyer are obtained by reducing the field agent's commission to reward the buyer for the work assumed by the buyer. And, with the one noted exception, there are still agents in the field who are compensated for their fieldwork, effectively sharing their compensation with the buyer to fund the rebate. The matching service and the agent in the field, which may be part of the same company, are paid and divide a fee. While in total the fees do not exceed the cost to the buyer in the traditional real estate business model, inherently the structure and fieldwork make the process more complex and therefore less efficient overall.

Thus, the predominant real estate buyer rebate model employed in the prior art still includes the agent in the field and a commission paid to this agent, ultimately by the seller. In the Internet era with Web-based search engines for matching property buyers and sellers, much of the need for a real estate agent in the field has all but been eliminated. It is inherently inefficient to include any unnecessary activities in a transaction because they increase complexity, which drives up costs without any compensating benefit. The functions of an agent in the field who brokers property viewing time and performs filtering are better accomplished by the decision-maker, i.e., the buyer. Even the sharing of an agent's fee with a proactive buyer requires additional approval steps and contributes to inefficiencies in the real estate purchasing process.

Users of Web sites have become accustomed to enabling technology in other (non-real estate) circumstances, such as one-stop shopping for all their needs, shopping carts to collect their selections, downloading turn-around documents (coupons), and viewing and updating their user profiles. Users have come to expect such broad-based supporting features when they shop on-line. And, users without this support have typically abandoned their purchasing activities when response is delayed, as it is when only e-mail or U.S. mail delivery of needed documentation is offered.

While buyer rebates are increasingly being offered as incentives, in all but the one Web site noted above, these rebate offers are being made in the context of the traditional real estate business model, retaining its inefficient use of agents in the field. At the same time, buyers are increasingly using Web-based Internet-accessible matching services to educate themselves about the real estate market and property availability. As a result, the real estate purchasing process has become more open. The process and associated data are more visible to all participants, so much so that purchasing property no longer requires an agent in the field to filter properties or conduct on-site tours. Further, any potential for eliminating process steps increases efficiency.

The one Web site that employs a business model explicitly eliminating the agent in the field, while increasingly successful, offers only limited services to both buyers and sellers due to its pioneering role as a proof-of-concept endeavor. This Web site offers only indirect and delayed delivery of rebate coupons, one-at-a-time property selection and couponing, and lists only properties of multiple property homebuilders, among other limitations. For its continued success this Web site must offer buyers the broad-based support they have come to expect when shopping on-line.

### SUMMARY OF THE INVENTION

Thus, there is a need for a full service real estate buyer rebate business model that eliminates the need for a real estate agent in the field to filter properties and perform onsite tours. The combined buyer/property matching and couponing model of the hosted real estate rebate system and method of the present invention meets this need. In a preferred embodiment, the present invention enables on-line property shoppers to receive, downloaded via a Web browser, self-service cash back coupons. These coupons are associated with self-conducted Web-based searches of seller property listings made available by a host Web site over the Internet.

Referring to FIG. 1 and FIG. 2, the real estate rebate system and method of the present invention is shown as a network-accessible host system and method 12 that signs up property sellers, e.g., new home builders and individual home sellers 13, in order to provide property buyers 10 who access the host's Web site and perform a property search, with downloadable cash back coupons and other supporting services. In a preferred embodiment the network 11 is the Internet and both buyers 10 and sellers 13 employ Web browsers to access the services of the host 12.

As illustrated in FIG. 2, in a preferred embodiment the host 12 includes a search engine 20, accounting functions 22, and sales support functions 23. All of these functions of the host 12 access local and remote databases 21, the former directly and the latter indirectly via a communications network 11. In a preferred embodiment this network is the Internet and this connectivity allows both business-to-business and consumer-to-business interactions to be facilitated by the host 12. For example, a host may provide additional services 25 to both buyers and sellers such as arranging for financing, home inspection, home repairs, etc., using business-to-business connectivity over the Internet. Or, the host may join the buyer or seller (consumer) with a third-party goods and services provider in a consumer-to-business connection.

In a preferred embodiment of the present invention, rebate coupons offered by the host are customized to the particular buyer and each builder and seller selected by the buyer. In this preferred embodiment, as an alternative to customized coupons, a buyer may clip pre-printed coupons from print media and then register these clipped coupons with the host. In either alternative, these coupons are presented to and accepted by the seller, and may be certified by the signature of the seller, obtained when the buyer visits the property being offered for sale. In the present invention, a “signature” is a manual or electronic mark or approval code which denotes the signor's acceptance of a paper or electronic document. The coupons are kept track of by a host accounting system 22 and are redeemed by the host sending a rebate check to the buyer, subsequent to the funding of the purchase of a property. In a preferred embodiment, the purchase process is accomplished without the personal intervention or assistance of a human real estate agent in the field. The host maintains history databases that record interactions between the buyer, the host and the seller. These history databases are also available for searches.

When the host signs up builders and other sellers, the builders and other sellers agree to pay the host a commission for each buyer delivered to the builder or other seller through the host's systems that eventually purchases a home from that builder or other seller. The host, in turn, has a separate agreement with the buyer in which the host agrees to pay a cash rebate to the buyer of each property listed in the host's system that purchases a home through the host's real estate rebate system. In effect, the host of the real estate rebate system of the present invention is acting as a cooperating broker and is offering discounted services to buyers utilizing the host's real estate rebate system. Since buyer brokers' services are generally paid by the builder or other seller (and are therefore “free” to the buyer), the form of the host's discounted service to the buyer is in the cash rebate paid to the buyer through the host's real estate rebate system.

An important aspect of the hosted real estate rebate system of the present invention is its proprietary contracts with builders and other sellers. These contracts authorize the host to include detailed information, e.g., property listings, about the builder or other seller's properties within the host's real estate rebate system databases and to access a seller's remote databases via a network as third party databases. The contracts also call for the builder or other seller to recognize the host as a cooperating broker, resulting in a commission paid by the seller to the host, on purchases of the builder's or other seller's properties through the hosted real estate rebate system that have occurred without an agent of the host's being physically present with the buyer in the field.

The rebate coupon model employed by the present invention is based on the proven retail coupon model. This buyer rebate coupon model rewards real estate buyers who do the search and on-site tour legwork to locate and qualify properties, with cash back that does not in any way rely on an agent in the field. A personalized or clipped pre-printed self-service cash back coupon is employed by the real estate rebate system and method of the current invention as the vehicle for rewarding the real estate buyer who eliminates the real estate agent in the field by performing this agent's functions: searching and filtering of properties and listing inventory, and conducting on-site property tours. In a preferred embodiment, this cash back coupon is presented to the potential buyer in a graphical display and can then be immediately downloaded and printed by the buyer. It is well known that any delay in the buyer decision-making process reduces the likelihood of a sale. Further, sellers are provided feedback from potential buyer onsite property tours in the form of buyer evaluations.

The real estate rebate system and method of the current invention include a property search and qualification engine 20 that provides access to local and remote databases 21 of property listings of builders and sellers who have previously agreed to pay the host a commission for sale of property to a buyer who has presented one of these personalized or clipped pre-printed and registered rebate coupons on a visit to the property and had the seller/builder accept it, possibly certifying it by signing it. Property listings, or listing inventory, represents real property for which the seller has agreed to pay the host as described above, and may include specific street addresses, specific subdivisions in which the seller builds homes or multiple subdivisions within one or more certain geographic regions being developed by a builder. The search engine solicits user preferences, to be used as search criteria, and saves them in an on-line database as a user profile. This profile is used by the search engine to rank selections from the on-line property listings, prior to their presentation to the searching buyer. Further, the on-line shopping aspects of the current invention incorporate the familiar shopping cart model in which a potential buyer can aggregate properties of interest into one or more groups and then take further actions with respect to each group. In a preferred embodiment the buyers and sellers also are provided access to other services 25 related to the purchase and sale of property, such as financing and home inspection.

The present invention helps buyers and sellers and increases the efficiency of the real estate purchase process by:

converting real estate practices to Internet processes;

providing a state-of-the-art shopping experience through the use of a shopping cart model which integrates buyer-directed search and selection with ranking capabilities;

replacing real estate agents in the field with information systems;

making the entire purchase process visible which increase its accuracy, reliability, and timeliness;

creating more efficient internal workflow processes;

creating a robust and scalable business model through the use of communications and distributed database technology;

capturing and delivering real estate business intelligence in the form of buyer profiles and buyer property evaluations; and

reducing administrative costs.

All of these effects create immediate cost savings and result in long-term efficiencies for buyers and sellers and the real estate industry as a whole.

### BRIEF DESCRIPTION OF THE DRAWINGS

A more complete understanding of these advantages and other advantages of the present invention may be acquired by referring to the following description taken in conjunction with the accompanying drawings, in which like reference numbers indicate like features and wherein:

FIG. 1 is a flow diagram of an embodiment of the real estate rebate system of the present invention that illustrates both networked and direct communications paths between system components.

FIG. 2 is a flow diagram of the host functions and database contents of a preferred embodiment of the real estate rebate system of the present invention in which the host system incorporates accounting and sales functions.

FIG. 3 is a flow diagram of the search engine matching and coupon generation and delivery processes and associated databases of a preferred embodiment of the host system of the real estate rebate system of the present invention.

FIG. 4a is a flow diagram of the buyer-driven property touring, coupon accepting or signing, and property evaluation processes according to a preferred embodiment of the real estate rebate system of the present invention.

FIG. 4b is a flow diagram of the buyer-driven pre-printed coupon clipping, registering and approval code obtaining and entering processes according to a preferred embodiment of the real estate rebate system of the present invention.

FIG. 5 is a flow diagram of the process of redeeming a rebate coupon by a buyer who closes on the sale of a property according to a preferred embodiment of the real estate rebate system of the present invention.

FIG. 6 is a flow diagram of the builder and seller sign-up process according to a preferred embodiment of the real estate rebate system of the present invention.

FIGS. 7a-7c illustrate a three step process of obtaining a customized rebate coupon with steps 1 and 2 serving as a fill-in buyer profile form which is presented to a prospective buyer using a Web browser, in a preferred embodiment of the real estate rebate system of the present invention.

FIGS. 8a-8c illustrate partial database schemas for the Buyer History, the Seller History, and the Customer Relationship and Contact Management databases, respectively, according to a preferred embodiment of the real estate rebate system of the present invention.

FIGS. 9a-9c illustrate a property evaluation form according to a preferred embodiment of the real estate rebate system of the present invention.

FIG. 10 illustrates a seller s ign-up form according to a preferred embodiment of the real estate rebate system of the present invention.

FIG. 11a illustrates a rebate coupon and FIGs. 11b and 11c illustrates conditions that attach to the acceptance of this rebate coupon by a buyer, according to a preferred embodiment of the real estate rebate system of the present invention.

### DETAILED DESCRIPTION OF THE INVENTION

Conventional real estate models, and all other prior art real estate rebate models, require licensed real estate agents or brokers to be “in the field.” “In the field” means that the agent or broker travels to various geographic locations, working with prospective homebuyers by accompanying them to the seller's location for on-site tours, and working with prospective home sellers through on-site events at the property, such as open houses. These on-site activities are typically required, particularly for agents or brokers representing homebuyers, in order for the agent or broker to receive a commission.

Most homebuilders selling homes require agents or brokers to physically accompany their clients on the very first visit the client makes to the homebuilder's sales office. If the agent or broker fails to accompany the potential buyer to the builder's sales office on the potential buyer's first visit, the agent or broker will be ineligible to receive a commission from the homebuilder.

The present invention allows for a real estate commission generating system and method wherein the agent or broker explicitly, by previous agreement with the seller, does not need to accompany the potential buyer to the seller's location on the potential buyer's first visit. At the same time, the host remains eligible to receive a commission from the seller should the potential buyer close on a home from that seller. This arrangement is achieved through the host's system and method, wherein the host procures agreement for active participation in the host's system by the seller prior to the host sending potential buyers to the seller's locations.

The host solicits participation in the host's system by potential buyers, who then utilize the host's system and method to receive a real estate rebate coupon from the host's network, valid for one or more of the seller's properties, without human interaction between host and prospective buyer. Any transaction that results requires no real estate agent or broker associated with the host to be physically present in the field for the host to receive a commission from the seller and, in turn, for the buyer to receive a rebate from the host after closing. The transaction and flow of funds can occur with no physical contact between host and buyer, and with no interaction in the field between host and seller. Rather, the entire interaction between host and buyer may be strictly through the host's system.

The rebate coupon issued by the host's system includes specific identifying information, including the potential buyer's name, address, phone number, and a unique identifying rebate coupon number. The rebate coupon is valid for a specific seller only, the seller being a seller that has previously agreed to participate in the host's system. The rebate coupon has no cash value, nor is it valid for any property by any seller. Rather, the rebate coupon is valid solely for the potential buyer that registered with the host through use of the host's system, and is valid only for those participating sellers for which the potential buyer registered using the host's system. The host's system and method of couponing is a new and non-obvious fully featured way of generating commission revenues for the host, paid by the seller, without the host having a real estate agent in the field.

Further, the rebate coupon's unique identifying number reduces the likelihood that rebate coupons will be tampered with, assigned, or otherwise adjusted to broaden their validity to include other potential buyers or sellers that are not using the host's system. Additionally, the rebate coupons include expiration dates designed to ensure that neither the host nor the seller has rebate or commission liability exposure for an indefinite period of time into the future. Rebate coupons include expiration dates requiring the potential buyer to present them to the seller within a specified period of time as well as requiring the potential buyer to sign a sales contract with a potential buyer to be eligible to receive a real estate rebate from the host after closing. Buyers may register and reregister as often as they like and for as many participating sellers as they like, thereby obtaining new rebate coupons with new unique identifying numbers and with new expiration dates for any participating seller.

The rebate coupons issued to the potential buyer by the host include a number of other eligibility requirements designed to protect the host and the seller from undue liability and to prevent other potential problems the host's system might otherwise cause. These requirements include the inability of the prospective buyer to utilize the rebate coupon while concurrently working with another real estate agent on the same property and the requirement that the potential buyer deliver the rebate coupon to the seller on a potential buyer's visit to the seller's location.

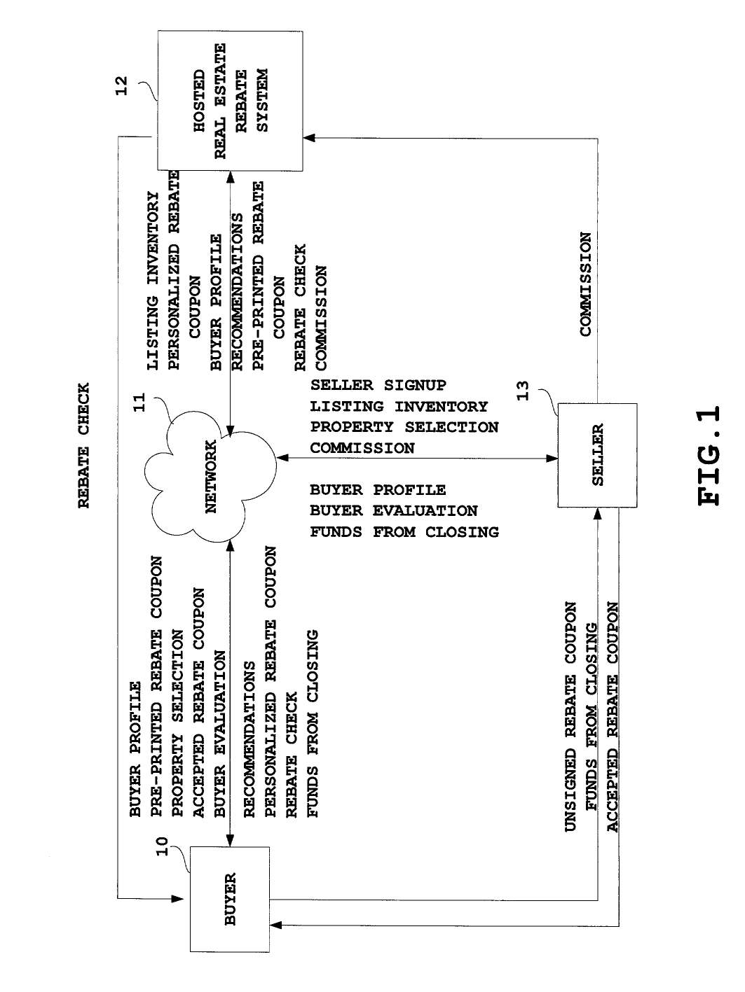

Referring to FIG. 1, in one embodiment both buyers 10 and sellers 13 access the hosted real estate rebate system 12 of the present invention using a communications network 11. In a preferred embodiment, this network 11 is the Internet and both buyers 10 and sellers 13 employ a Web browser to access the host 12. Such access may be over landline, wireless, or other type of connection.

### SIGNING UP SELLERS

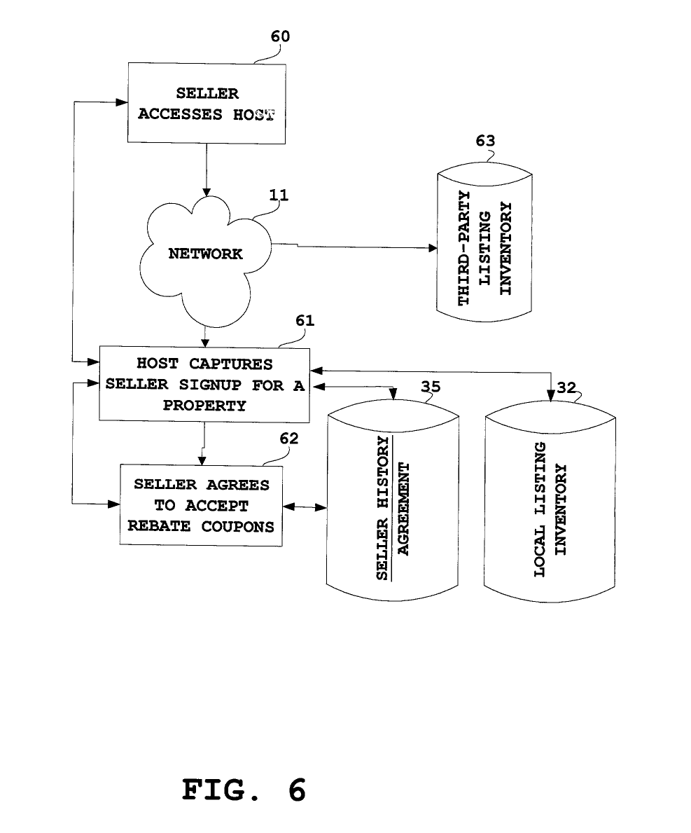

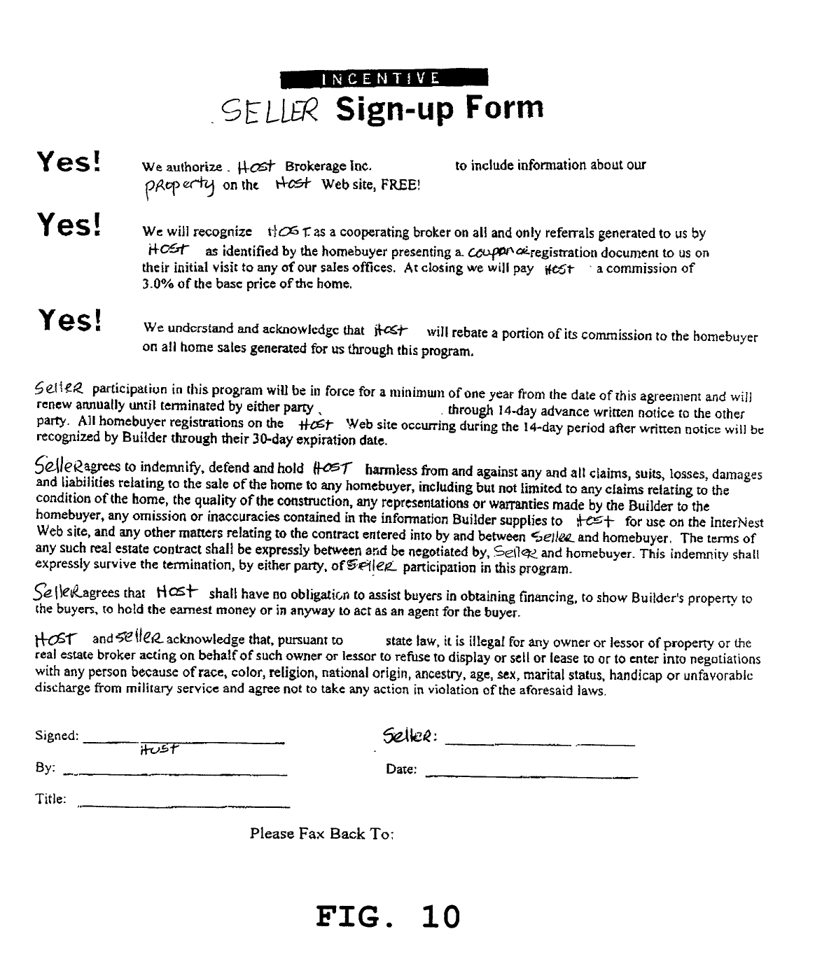

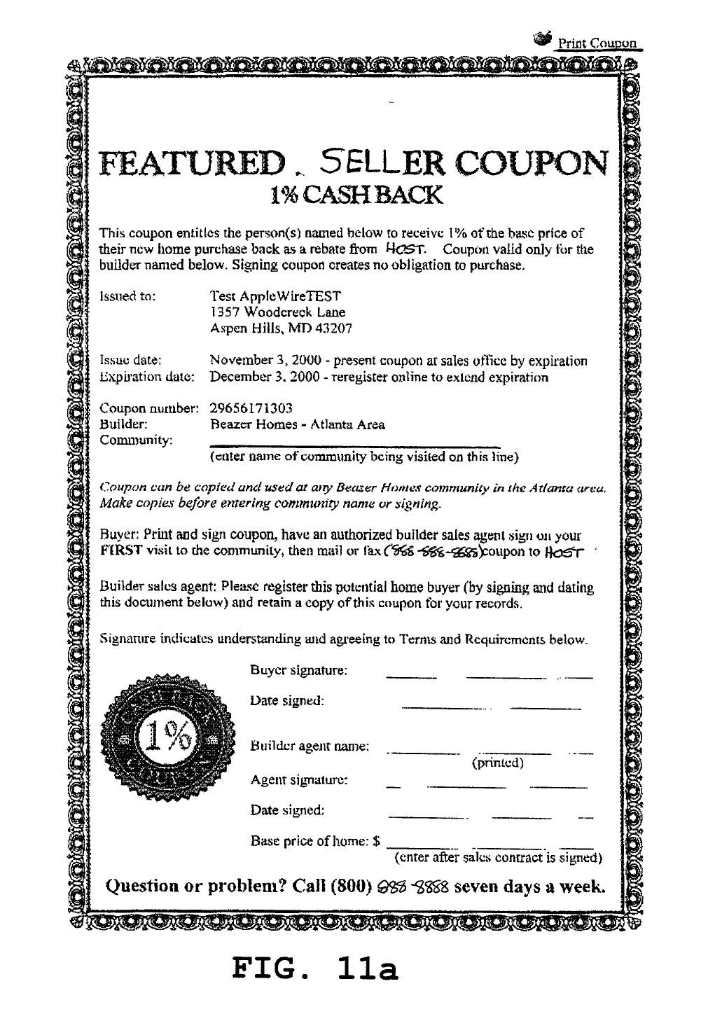

Referring to FIG. 6, an inventory of available properties can be obtained by accessing existing third-party Listing Inventory databases 63, such as the MLS (multiple listing service) database, and it can be created by a host during builder and individual property seller sign up 61. The hosted real estate rebate system of the present invention provides a network 11 accessible user interface 60 for signing up sellers. In a preferred embodiment the user interface is a Web browser that accesses the host over the Internet 11. During the sign up process each seller signs an agreement to pay a commission to the host on sales to buyers utilizing the host's real estate rebate system, as illustrated in FIG. 10.

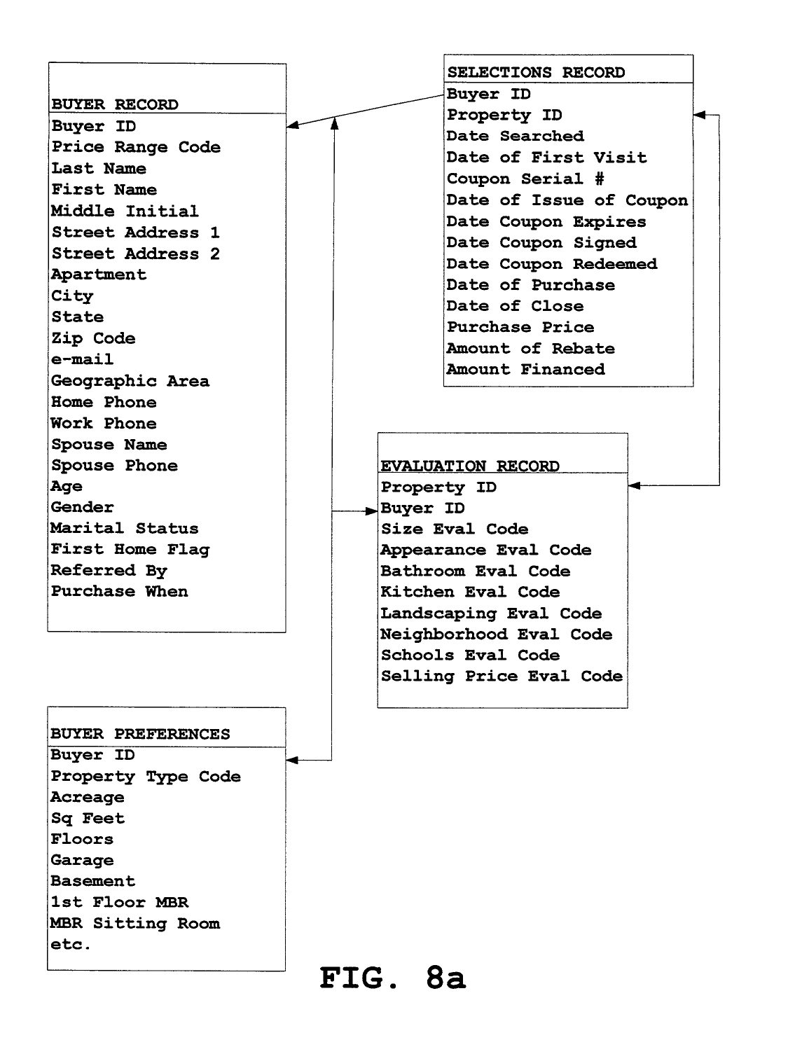

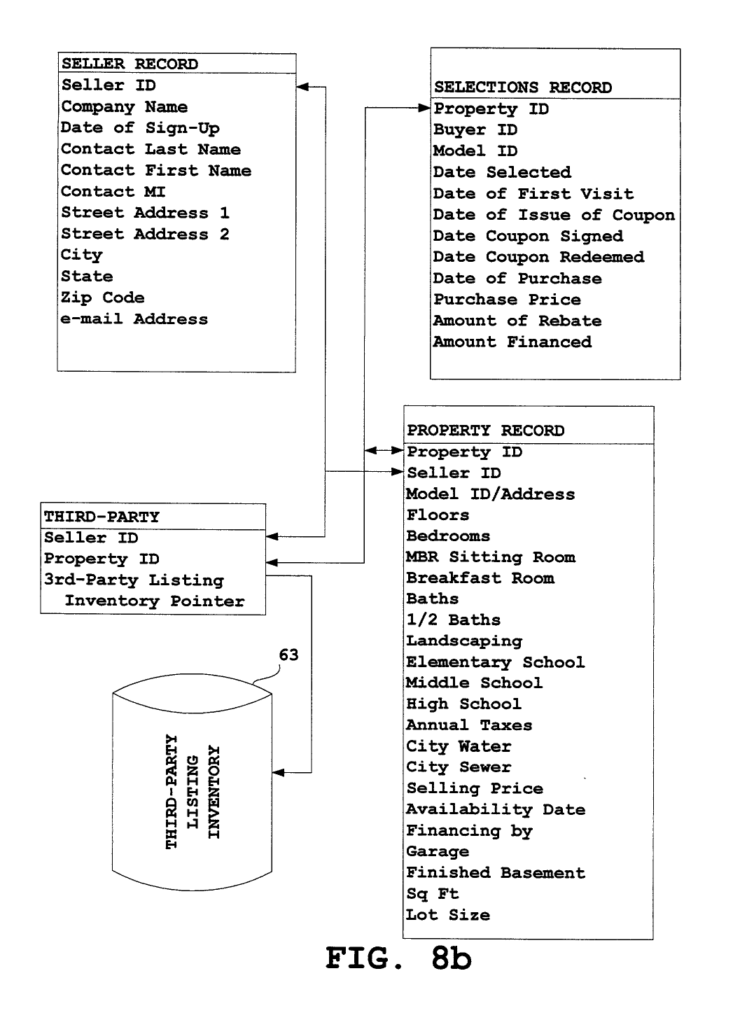

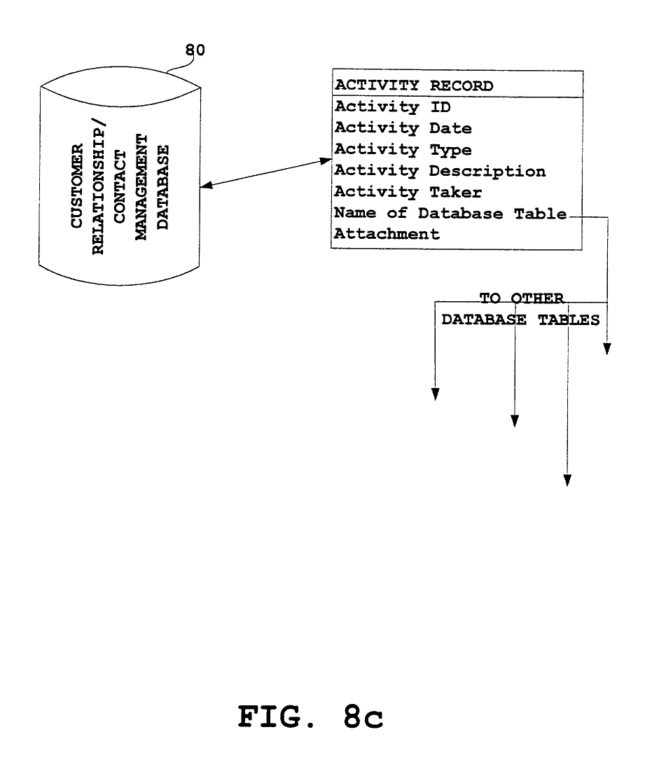

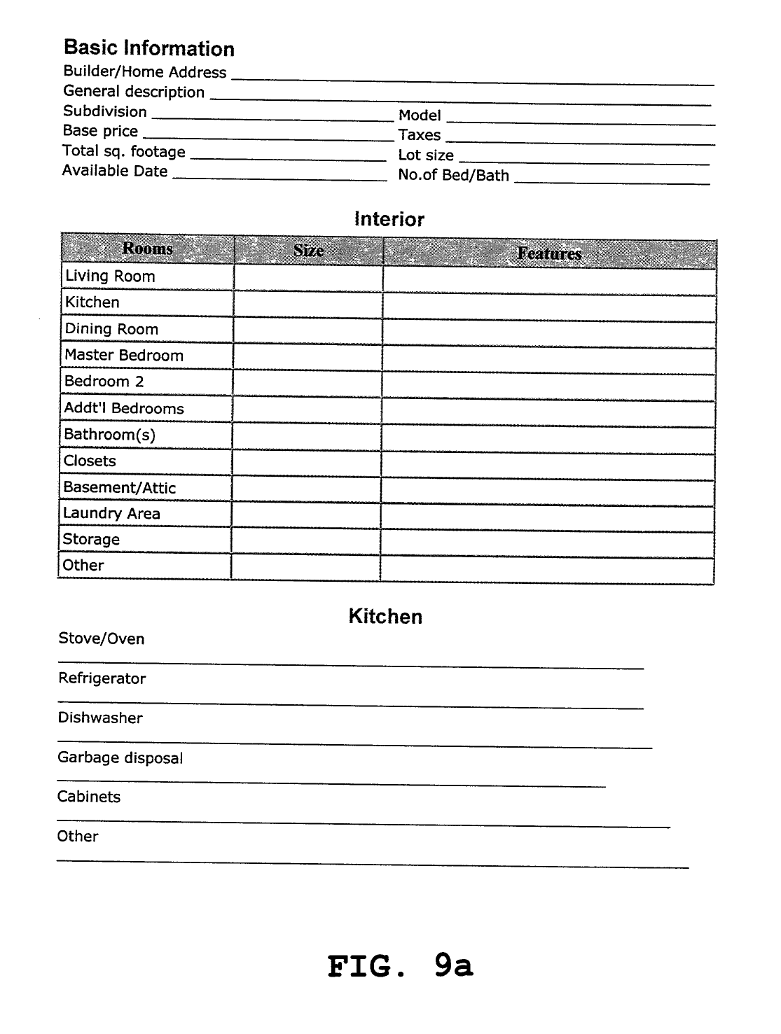

In this preferred embodiment, the seller is presented with a fill-in sign up agreement form 61, as illustrated in FIG. 10, in which the seller agrees to accept a host generated registration document (customized rebate coupon) that is presented by a buyer on their visit to the property or sales office. A database entry, as illustrated in FIG. 8b, is created for the seller in the Seller History database 35. In the preferred embodiment this Seller History database entry may point to a third-party Listing Inventory database 63 which will be accessed during searches for matching properties. In this preferred embodiment, this access to a third-party Listing Inventory database 63 is transparent to the buyer.

In an alternative embodiment, the seller agrees to accept the customized rebate coupon on the condition that an agent in the field register at the seller's location within a specified time period (48 hours, for example) after the buyer presents the coupon. In this embodiment, rather than substituting for an agent, the coupon allows the agent to visit the seller at a time convenient for the agent instead of a time convenient for the buyer, while still allowing the host to be eligible for a commission from the seller.

In a preferred embodiment, listing a property by the host is free of charge, though listings with preferred placement may require a fee. Access by prospective buyers to the host, searching for matching properties, and obtaining customized rebate coupons is free of charge. The seller pays for the host services by agreeing to pay a commission, typically around 3%, of the base or total price of the property to the host when a sale is closed. The host indicates its intention to, at its sole discretion, rebate a portion of its commission to the buyer. Both of these agreements are explicitly stated in the agreement illustrated in FIG. 10.

### MATCHING A BUYER PROFILE TO AVAILABLE PROPERTIES

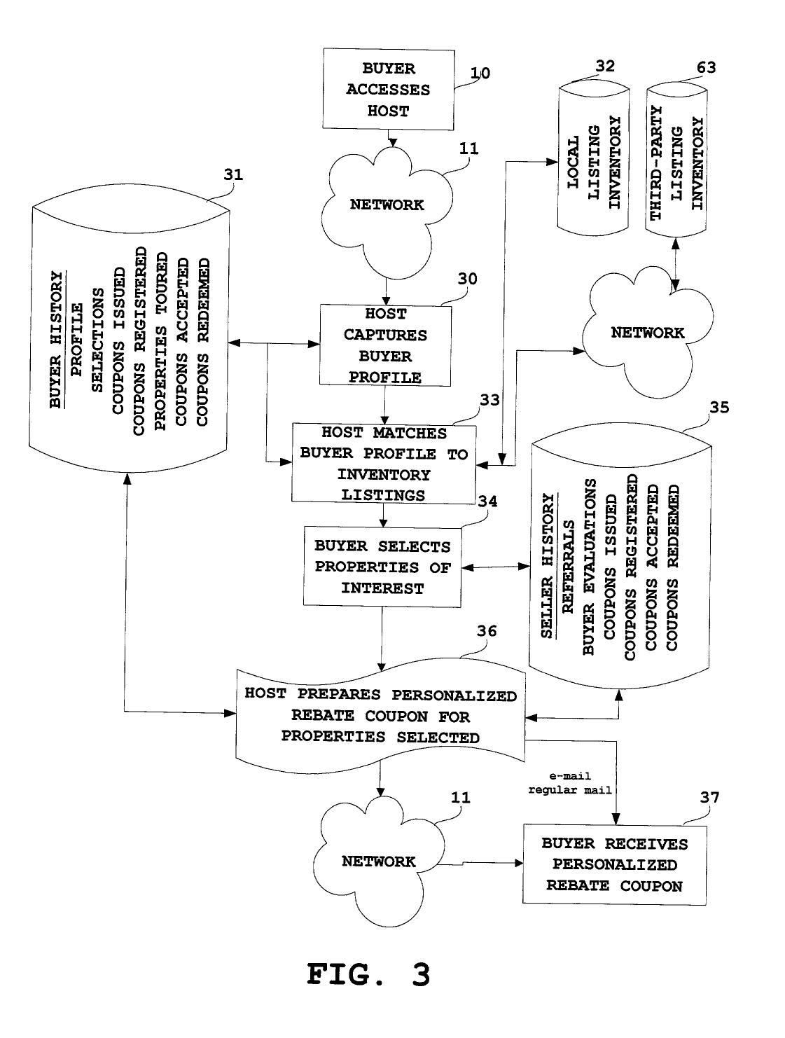

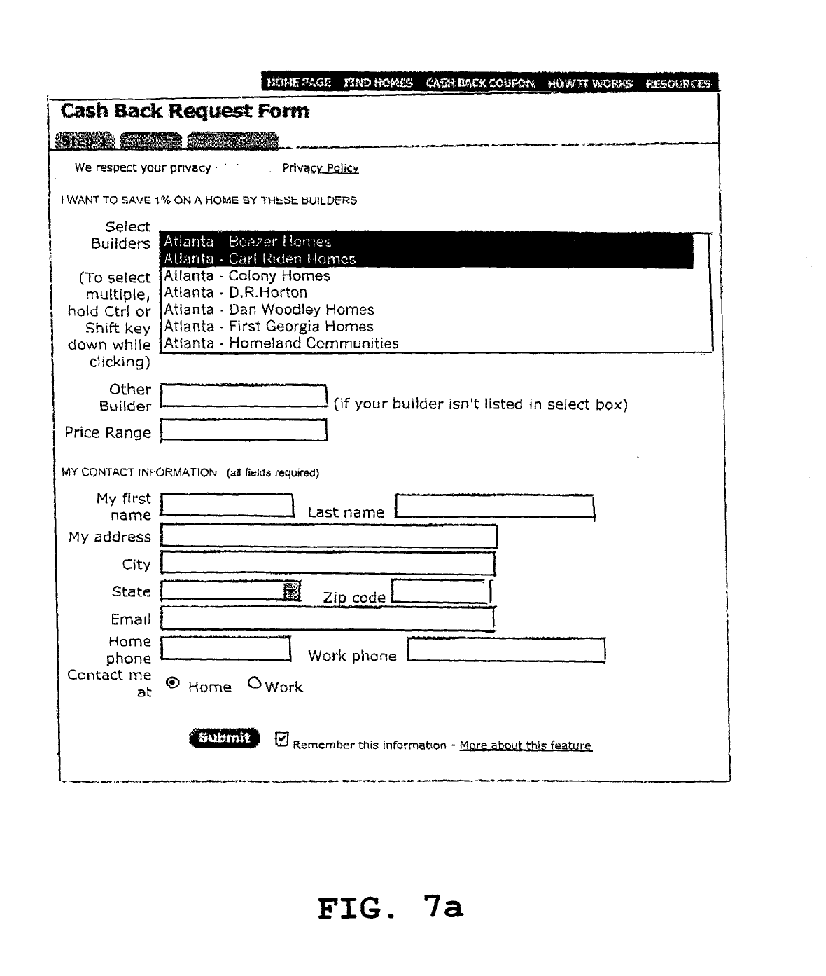

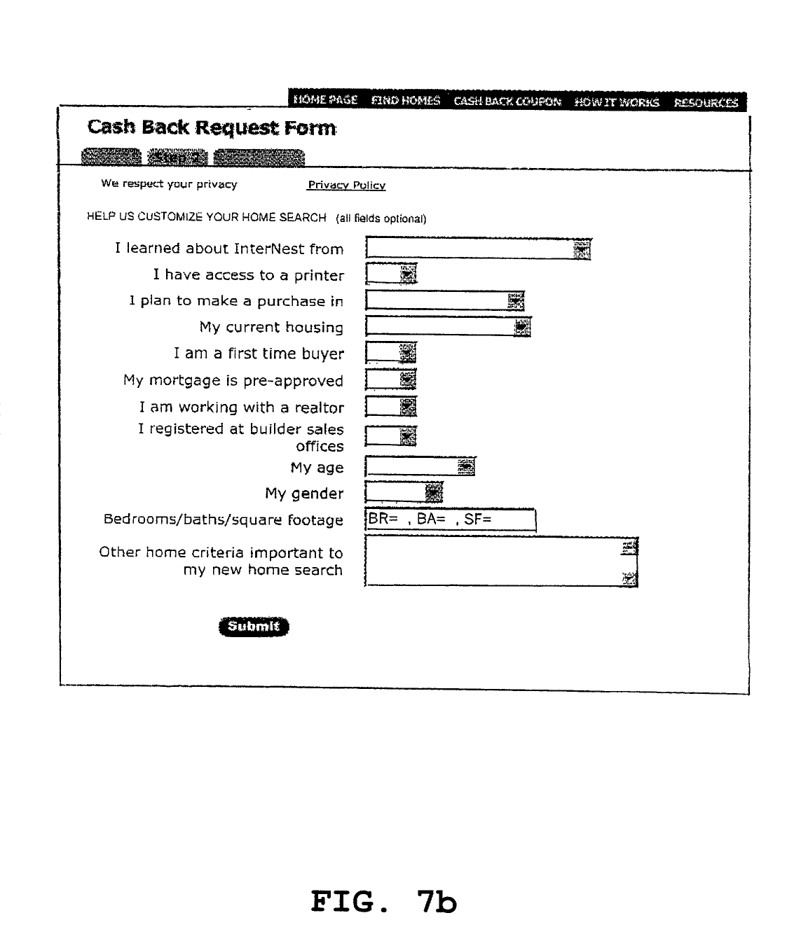

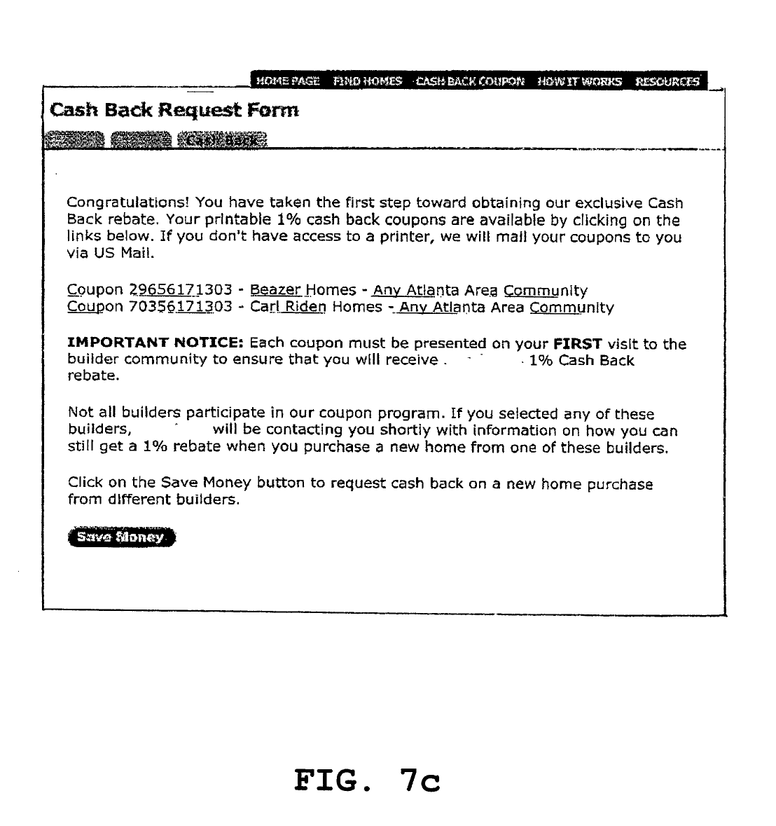

Referring to FIG. 3, a potential buyer 10 accesses the host via a communications network 11. The host captures a profile 30 of the potential buyer. In a preferred embodiment the user accesses the host using a Web browser and is presented with a fill-in style form as illustrated in FIGS. 7a-7b. This user profile is stored in a Buyer History database 31, whose partial schema is illustrated in FIG. 8a. The host matches 33 the buyer profile with available Listing Inventory databases 32 and 63. This Listing Inventory is both local 32 to the host and made accessible to the host by a third party 63 over a communications network 11, which in this preferred embodiment is the Internet.

A list of candidate properties that match the buyer profile is presented to the buyer and the buyer selects properties of interest 34. In a preferred embodiment, to increase the productivity of the buyer and to help organize the buyer's decision-making process, the rebate system provides the buyer with the capability of aggregating properties of interest into one or more groups (also known as ‘shopping carts’). Such aggregation allows actions to be taken with respect to the entire group, such as requests for rebates coupons, instead of being performed multiple times for each member of a group.

The present invention, in a preferred embodiment, uses a ranking system to return listing inventory search results to the buyer in ranked order, with the highest ranked listings appearing at the top of the listing. The rankings are designated with icons, hammers or stars being examples of such icons. In a preferred embodiment, for example, the highest rated listings may be “5-hammer” homes while the lowest rated listings would be “1-hammer” homes. These rankings are derived using a proprietary formula that takes into account many factors, including: absolute price, price relative to other homes in its geographic area or market, proximity to cultural resources, school and community information, and other demographic data such as crime statistics for the neighborhood the home is located in.

The ranking formula is defined below. If the result of the ranking is displayed using icons, in an alternative embodiment, the rank is rounded to the nearest whole integer so partial icons do not have to be drawn.

Rank=(R1+R2+R3+R4+R5)/10

Where:

R1 thru R5 are ranking factors, each having a minimum value of 2 and a maximum value of 10, providing R a possible range of 1 to 5. If a given ranking factor cannot be computed due to lack of information, that ranking factor is assigned a value of 0 and R is multiplied by (5/# of remaining factors). For example, if R2 and R4 cannot be computed then the formula becomes:

R=((R1+0+R3+0+R5)/10)*(5/3)

Thus the formula can more precisely be defined as:

Rank=((R1+R2+R3+R4+R5)/10)*(5/# of non-zero ranking factors)

In a preferred embodiment, the ranking factors are defined as follows. In each case an upper and lower value for the range of the ranking factor are given and the values in between are interpolated:

R1 is derived from the absolute price of the listing. For listings over $2,000,000, R1=1, and for listings under $200,000 R1=10.

R2 is derived from the relative price of the listing compared to other homes in the area. For listings within 10% of the mean for the area, R2=10, and for listings only within 90% of the mean for the area, R2=2.

R3 is derived from the distance of the listing to a major cultural center such as a large city. For listings within 10 miles of a cultural center, R3=10, and for listings within 100 miles, R3=1.

R4 is derived from the ranking of the public high schools in the area by standardized test scores. For listings in school districts in the upper 10% of the state, R4=10, and for listings in the lower 10%, R4=1.

R5 is derived from crime statistics for the city or village the listing is located in or is nearest to. For listings located in an area within the lower 10% of the state in terms of major crimes per person, R5=10, and for listings in the upper 10%, R5=1.

In an alternative embodiment, the rankings also employ buyer profile and buyer history data as inputs to the rankings. This embodiment ranks listings differently depending on which buyer is searching the Inventory Listings.

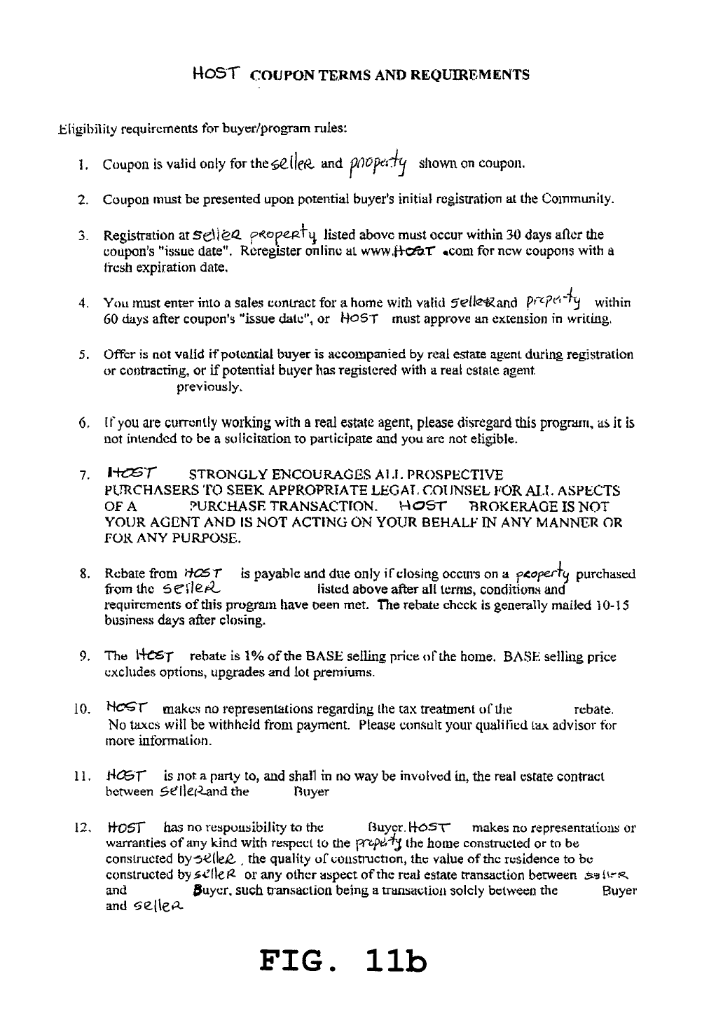

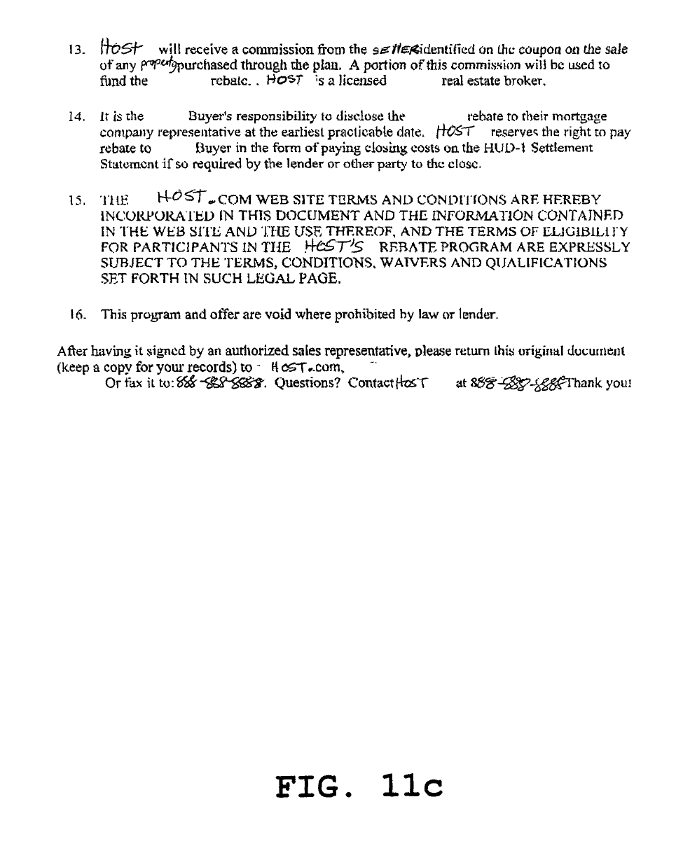

Referring now to FIGS. 8a and 8b, the entries in the SELECTIONS record of both the Buyer History database 31 and the Seller History database 35 for the properties selected by the buyer are updated to reflect the buyer's selection. The host then prepares a personalized registration document or rebate coupon 36, as illustrated in FIG. 11a, for each buyer-seller pair and records the issuance of each coupon in the SELECTIONS record of both the Buyer History database 31 and the Seller History database 35. If the seller is a builder with multiple communities, the buyer fills in the name of the community. Typical terms and conditions for the rebate coupon are contained in FIGs. 11b-11c. The rebate coupon is delivered to the buyer over the communications network 11 or by e-mail or regular mail. In the preferred embodiment, delivery is by downloading the coupon over the Internet using the buyer's Web browser 37. The buyer then prints the downloaded coupon.

### PRE-PRINTED COUPONS

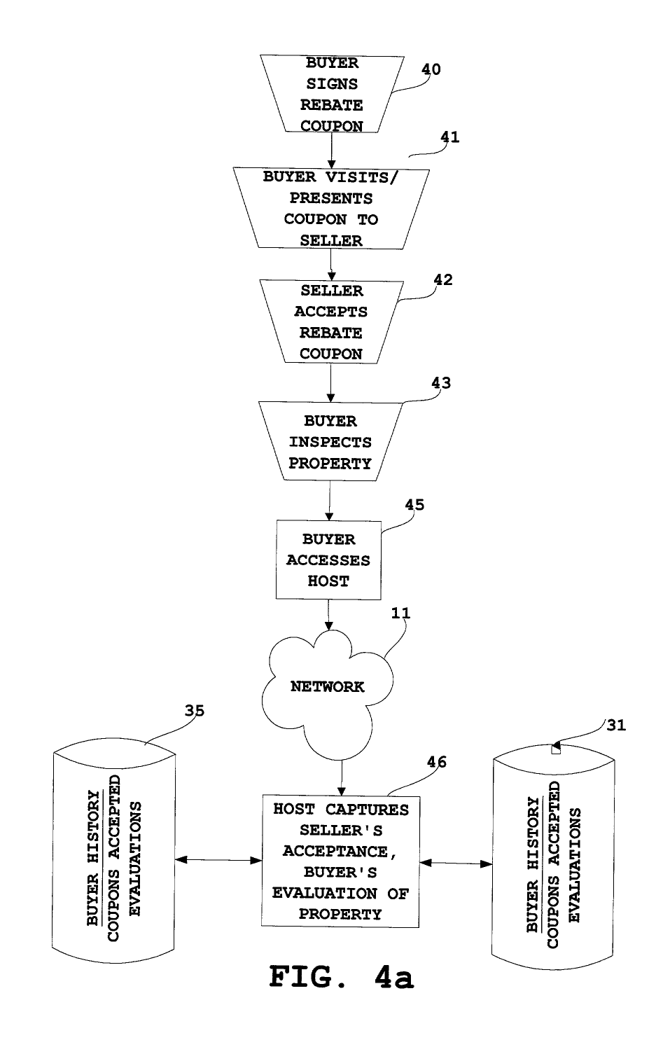

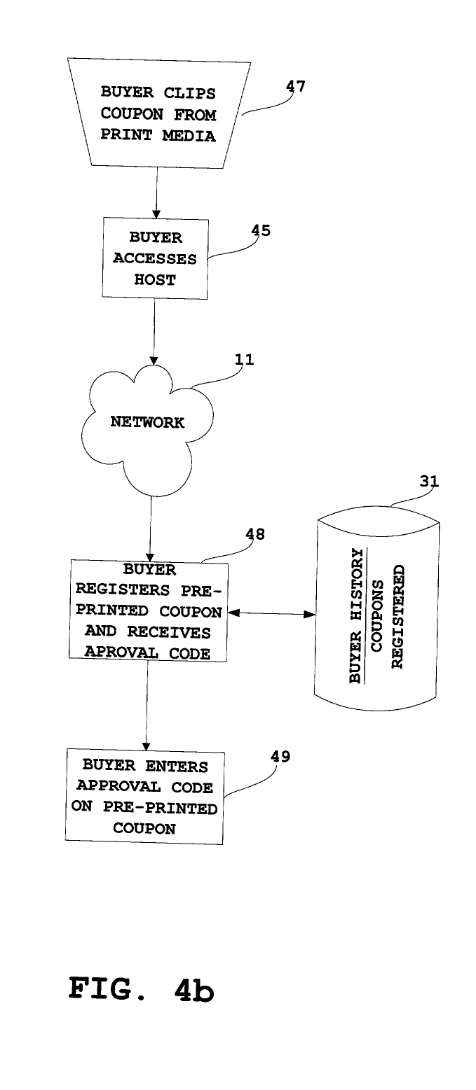

Referring now to FIG. 4b, in an alternative embodiment, coupons are pre-printed in print media such as new homes guides and newspapers and are clipped by potential buyers 47. The pre-printed coupons indicate the builder and/or properties the coupon is valid for, list the expiration date, and have a space for the buyer to enter their name and address. The pre-printed coupon also has a special request code, unique to each builder, that the buyer must access the host 45 and register 48 with the host. Upon receipt of the request code, the host issues an approval code to the buyer that the buyer then enters it on the coupon before presenting it to the seller for acceptance. The seller can verify the authenticity of the approval code using instructions provided by the host when the seller originally signed up with the host.

### EVALUATING THE SELECTED PROPERTY

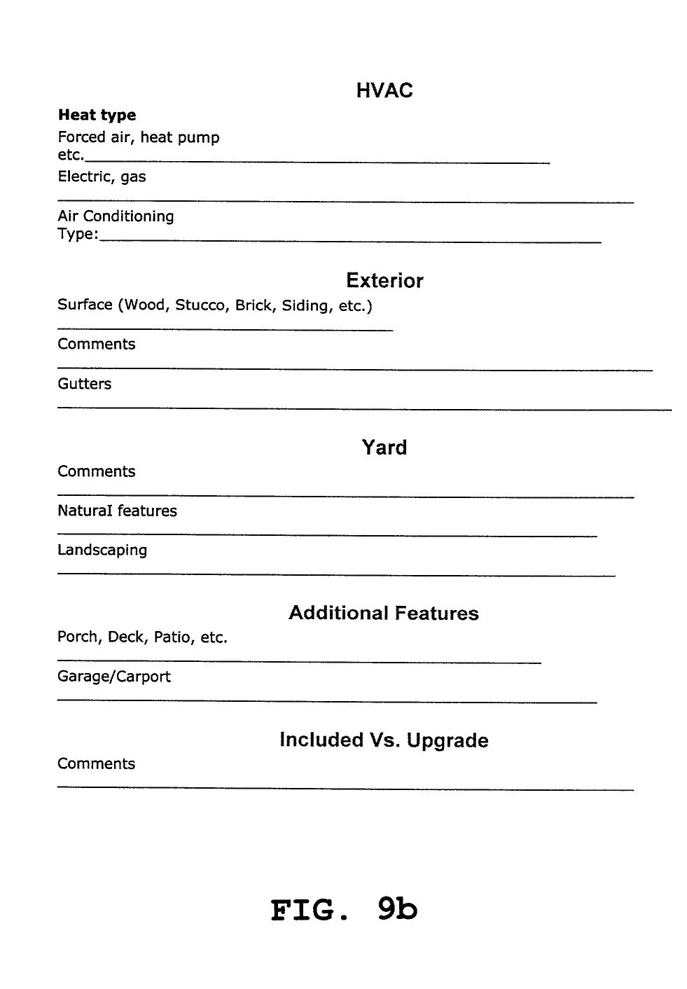

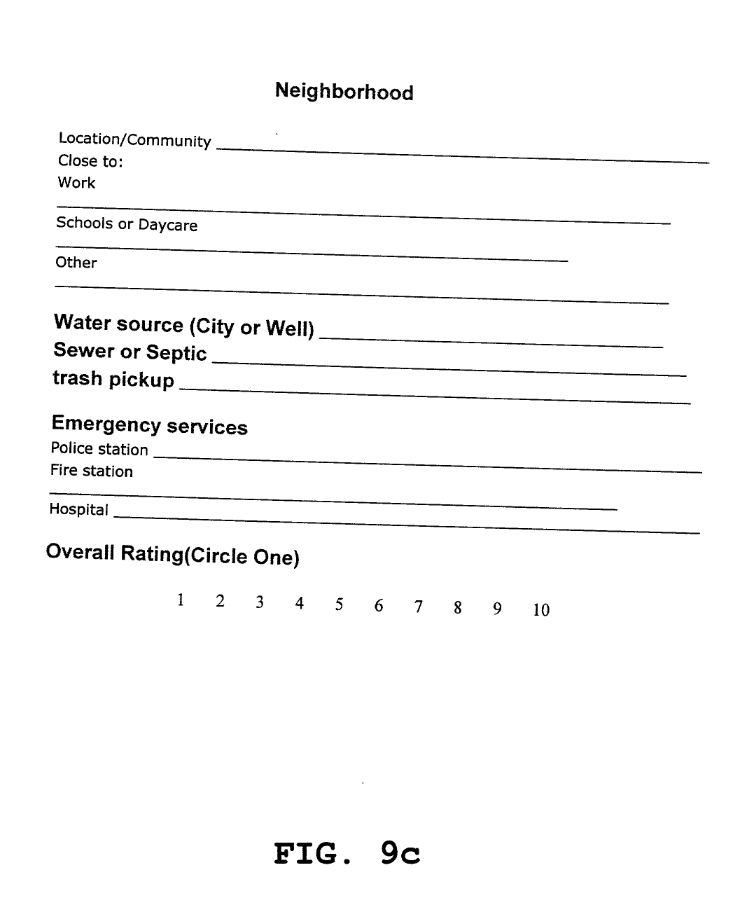

Referring now to FIG. 4a, once the buyer is in physical possession of a personalized rebate coupon for a builder, the buyer signs the rebate coupon and fills in the community name, if necessary. Then, the buyer visits the property and presents the rebate coupon to the seller 41 for signature by the seller or the seller's agent 42. The buyer then inspects the property 43 and subsequently provides feedback by accessing the host 45 over a communications network 11. In a preferred embodiment, the buyer uses a Web browser to access the host over the Internet. The host presents the buyer with a fill-in property evaluation form 46, as illustrated in FIG. 9, and the host updates the Seller History 35 and Buyer History 31 databases appropriately to reflect the visit and buyer's evaluation. If a coupon has been signed by a seller or seller's agent, the host records that a signature has been obtained in both the Buyer History database 31 and the Seller History 35 database.

### DATABASE ACCESS BY BUYERS AND SELLERS

In an alternative embodiment, each seller can access the host's databases and view records, e.g., buyer preferences, selections, evaluations, and sales. This sharing of information concerning buyers provides sellers with feedback that allows the sellers to adjust their property offerings to meet buyer needs and prevailing real estate market conditions. In another alternative embodiment, buyers also have access to the host's databases so that buyers can adjust their expectations to conform to market conditions.

Such readily available information access tends to regularize a marketplace, contributing to overall marketplace efficiency that benefits all participants.

### REDEEMING AN ACCEPTED REBATE COUPON

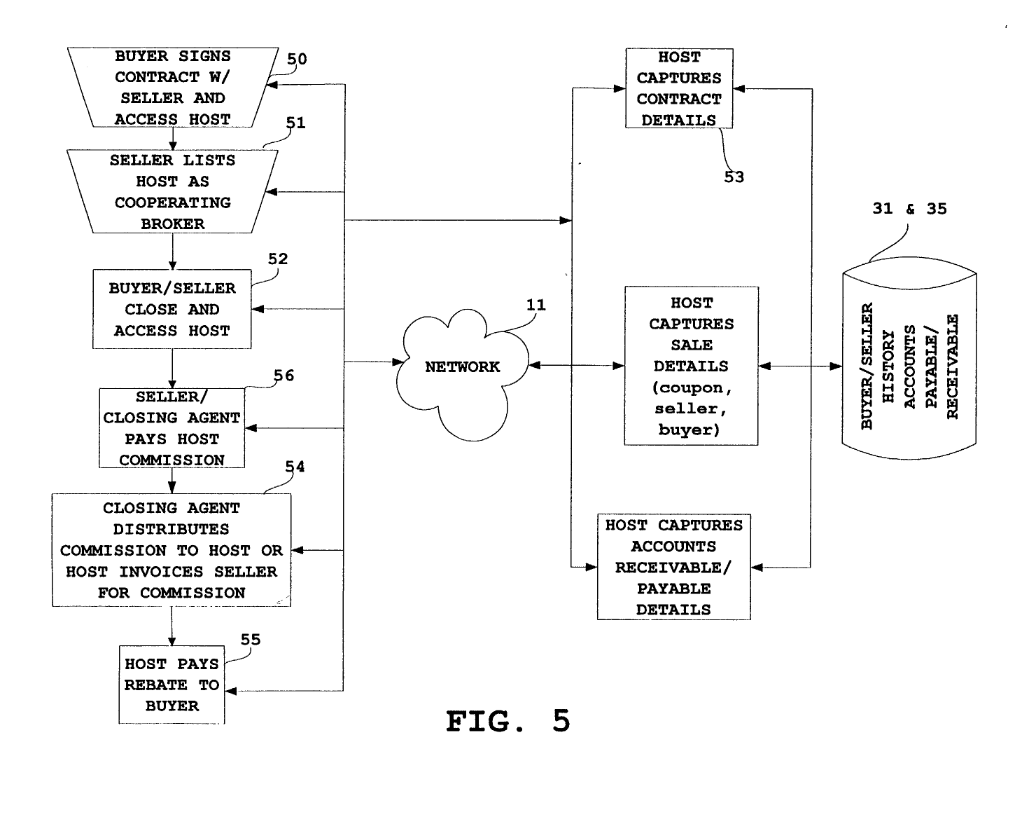

The buyer finds a property that meets the buyer's criteria, obtains a personalized rebate coupon, visits the property and has the rebate coupon accepted by the seller, makes an offer, and the offer is accepted. Then, referring to FIG. 5, the buyer signs a contract with the seller 50 in which the seller lists the host as the cooperating broker 51. A date is set for closing and the buyer and seller close, the sale is funded by a lender, and the host is accessed 52 using a communications network, to inform the host of the funding of the purchase. In the preferred embodiment the communications network is the Internet and a Web browser is used to access the host. The host captures the details of the sale 53, e.g., notes the existence of an accepted rebate coupon, the selling price, etc., and updates both the Buyer History 31 and Seller History 35 databases appropriately, to reflect the sale and existence of an accepted rebate coupon. The host receives the commission from the closing agent at or after closing, or invoices the seller for the commission 54 and when the seller pays the host the commission 56 the host issues a rebate check to the buyer 55. Any of these payments can be made by electronic funds transfer and can take place over the Internet.

These various purchase related transactions are recorded in the Buyer History 31 and Seller History 35 databases as they occur and cause appropriate corresponding entries in the accounts payable and receivable 22 maintained by the host.

### MARKETING AND SALES

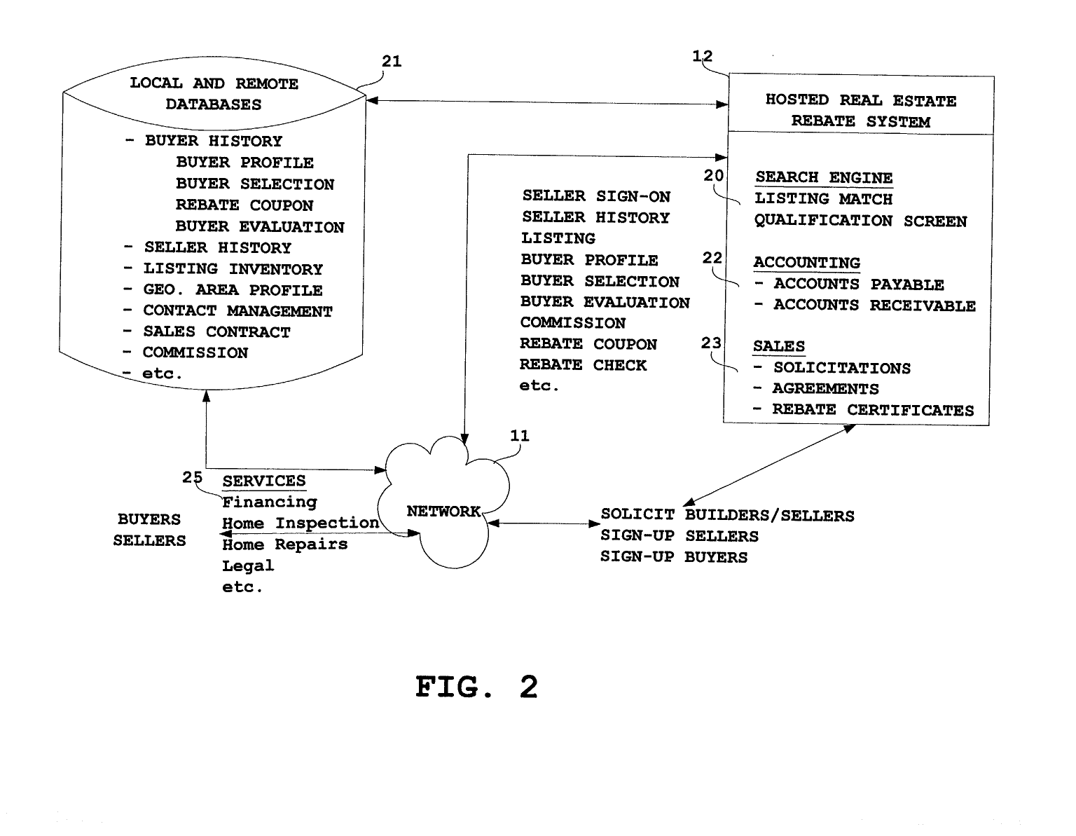

Referring to FIG. 2, a database of users of the hosted real estate rebate system of the present invention is utilized to further market listings and properties of builders and other sellers. Referring to FIG. 8c, the host system can interface the real estate rebate system to any of (1) automatically generated and timed e-mail follow ups, (2) Customer Relationship Management database 80 and system, (3) lead source tracking system, and (4) various automated distributions of information between prospective buyer and builder or other seller, and can track any other activities, as illustrated in the ACTIVITY Record of FIG. 8c.

The host's real estate rebate system is also marketed directly to consumers as a unique program designed to benefit consumers through the information resources and services available via the host such as the relationships and contacts the host has with builders and other sellers, the host's customer service department to handle specialized research needs of the buyer, the host's expertise as a licensed real estate broker in all markets in which it operates, and the host's proprietary coupon cash rebate system which saves the buyer money on their home purchase.

The foregoing description of a preferred embodiment of the real estate rebate system of the present invention has been presented for the purposes of illustration and description. It is not intended to be exhaustive or to limit the invention to the precise form disclosed. Many modifications and variations are possible in light of the above teaching. Such modifications and variations are deemed to be within the scope of this invention.

We claim:

1. A system for a host to selectively provide rebate coupons to potential buyers of real property, said system comprising:
a host system;
at least one remote communications facility;
data storage means within said host system for maintaining databases containing a plurality of data records of differing types and chronologies;
computer processing means within said host for selecting data records and transmitting said selected data records to said at least one remote communications facility according to selection criteria provided by said at least one remote communications facility;
communications network means associated with said host system, said communications network means being controlled by said computer processing means to exchange data between said host computer system and said at least one remote communications facility;
computer input-output means at said at least one remote communications facility to enable at least one of:
a. for potential buyers to obtain one of i) specification of selection criteria for said data records and display of selected data records meeting said selection criteria and receipt of a rebate coupon for at least one property corresponding to said selected data records, and ii) registration of at least one pre-printed rebate coupons clipped from a print medium from said host using a request code printed on said at least one pre-printed rebate coupon and receipt of an approval code that the buyer prints on said at least one pre-printed rebate coupon;
b. for sellers to sign up properties for inclusion as listing inventory data records in said databases,
c. for sellers to agree to one of i) acceptance of said rebate coupons and said at least one pre-printed rebate coupon as a substitute for an agent in the field, and ii) acceptance of said rebate coupons and said at least one pre-printed rebate coupon if an agent in the field visits the seller within a certain time period after the buyer presents said rebate coupons and said at least one pre-printed rebate coupon, and
d. for sellers to fund a commission to said host for the sale of a property corresponding to one of said rebate coupons and said at least one pre-printed rebate coupon.

2. The system according to claim 1, wherein:
said computer input-output means at said at least one remote communications facility provides for the buyer to indicate properties visited.

3. The system according to claim 1, wherein:
said computer input-output means at said at least one remote communications facility provides for the buyer to indicate as accepted by the seller one of said rebate coupons and said at least one pre-printed rebate coupon.

4. The system according to claim 1, wherein:
said computer input-output means at said at least one remote communications facility provides for sellers to specify selection criteria for said data records and to display said selected data records meeting said selection criteria.

5. The system according to claim 1, wherein:
said host system and said at least one remote communications facility exchange data through the Internet; and
said computer input-output means employs a Web browser.

6. The system according to claim 5, wherein said host is enabled such that each said rebate coupon issued is identified as issued only to the selecting buyer.

7. The system according to claim 5, wherein said host is enabled such that each said rebate coupon issued for a builder of multiple participating communities can be identified as pertaining to only one of these communities by the potential buyer.

8. The system according to claim 5, wherein:
said databases include at least one third-party remote listing inventory database;
said remote communications facilities include at least one third-party listing inventory database system; and
said communication network means further comprises communication network means for exchanging listing inventory data records between said host computer system and said thirdparty listing inventory database system.

9. The system according to claim 5, wherein whenever a new potential buyer accesses said host, said host system is enabled to solicit buyer information and together with buyer preferences stores these in said data records collectively in said databases to form a buyer profile.

10. The system according to claim 5, wherein:
said computer input-output means further provides for potential buyers to specify evaluations of selected properties visited; and
said computer processing means further provides for the capture of said evaluations in said data records for a selected property visited by a potential buyer.

11. The system according to claim 5, wherein:
said databases further comprise ranking data including property pricing and demographic data records;
said computer processing means ranks said selected property database records using a formula that takes into account said property pricing and said demographic data prior to transmission of said selected property records to said remote communications facilities.

12. The system according to claim 5, further comprising means at the host for aggregating said selected records into a group for further processing actions to be taken with respect to each said data record contained in said group.

13. The system according to claim 5, wherein:
said computer processing means generates an accounts receivable data record for the seller of each property sold to a buyer using said host system; and
payment of said receivable by the seller triggers update of said accounts receivable data record, creation of an accounts payable data record, and payment by said host of a rebate to the buyer.

14. The system according to claim 13 wherein at least one of said payments is accomplished by electronic funds transfer.

15. The system according to claim 5, further comprising means at the host to enable potential buyers at each said at least one remote communications facility to electronically negotiate purchase price of a selected property with the seller of that selected property.

16. The system according to claim 15, further comprising means for the host to generate and transmit to a remote communication facility purchase necessary contract and documents for any one of financing, paying, repairing, inspecting, assessing, insuring, a property selected by a buyer or a seller at said remote communication facility.

17. A method of automatically generating and issuing real estate buyer rebate coupons to potential buyers through a communications network comprising:
a host system for signing up sellers to pay a commission to one of (i) the host for each buyer delivered to the builder, and (ii) other seller through the host's systems that eventually purchases a home from that builder or other seller;
obtaining a listing inventory of property to be sold with a buyer rebate funded by the host;
maintaining databases at the host which contain data records of different types and chronologies;
providing by the host system to remotely accessing users access via the communications network to specify selection criteria;
searching by the host system said maintained databases based on said selection criteria; and
delivering results of the searching step to the remotely accessing users;
providing by the host the ability to select properties to tour from the delivered results; and
processing rebate coupons by the host for properties selected to tour.

18. The method according to claim 17, wherein the communications network is the Internet and the remotely accessing users employ a Web browser.

19. The method according to claim 17, wherein the processing step further comprises the steps of:
registering by a remotely accessing user of at least one pre-printed rebate coupon clipped from a print media;
receiving by the remotely accessing user of an approval code from the host for each said at least one pre-printed coupon registered; and
printing by the remotely accessing user the received approval code on each coupon registered.

20. The method according to claim 17, wherein the processing step further comprises the steps of:
generating a rebate coupon; and
delivering the generated rebate coupon to the remotely accessing user.

21. The method according to claim 17, further comprising the step of:
accepting the rebate coupon by the seller during a tour.

22. The method according to claim 21, further comprising the step of:
designating the host system as the cooperating broker by the seller.

23. The method according to claim 22, further comprising the steps of:
buying the property by the potential buyer; and
paying by the host system of the buyer rebate when the seller pays the commission.

24. The method according to claim 23, further comprising the step of:
invoicing by the host system of the seller for the cooperating broker's commission.

25. The method according to claim 24, further comprising the step of:
recording by the host at each step of the method information about each step in the data records.

26. The method according to claim 25, further comprising the steps of:
ranking by the host system of the search results with a formula that takes into account property pricing and demographic data prior to delivery of the results of the searching step,;
capturing by the host system of an evaluation of the toured property in an evaluation record of said databases; and
aggregating by the host system selected properties into a group for further processing actions as a group.

27. The method of claim 25, wherein said listing inventory includes at least one remote third-party listing inventory database.

28. The method of claim 25, further comprising the steps of:
soliciting by the host of buyer information; and
storing by the host in a database as a buyer profile said solicited buyer information and said buyer property selection criteria; and
selectively providing to remotely accessing users said buyer profile.
